(19) United States
(12) Patent Application Publication
(10) Pub. No.: US 2005/0166259 A1
(43) Pub. Date: Jul. 28, 2005

(54) Information security awareness system

(75) Inventor: Lars Neupart, Frederiksberg (DK)

Correspondence Address: KLEIN, O'NEILL & SINGH, 2 PARK PLAZA, SUITE 510, IRVINE, CA, 92614, US

(73) Assignee: NEUPART APS, Copenhagen V (DK)

(21) Appl. No.: 10/501,302

(22) PCT Filed: Jan. 10, 2003
(86) PCT No.: PCT/DK03/00016

(30) Foreign Application Priority Data
Jan. 10, 2002 (DK) PA 2002 00036

(51) Int. Cl. H04L 9/32

(52) U.S. Cl. 726/1; 713/200

(57) ABSTRACT

A computer system for providing security awareness in an organization, comprises: a memory means, an input device, constituted by a hard disk or Random Access Memory device, a central processo unit connected to the memory means, an input device, constituted by a mouse or keyboard device, and an output device, constituted by a printer or display device. The input device is connected to the central processor unit, for the input of a piece of security information into the computer system for storing the security information in the memory means as an information security object. The output device is connected to the central processor unit for the output of security information. The system further comprises a policy module communicating with the input device and the memory means for the conversion of the piece of security information into the information security object to be stored in the memory means, and a survey module communicating with the memory means and the output means for generating from the information security object an element of a questionnary to be output by means of the output device.

The invention relates to a computer system and a method providing on a modular platform security policy management, security survey, security education, risk analysis and management, incident management and audit functions to individuals in an organization. The elements are used all together or separately. By utilizing the technique according to the invention users gain multilanguage security policies and rules, policy based and auto generated surveys, increased security awareness, increased knowledge and ability to impact their actions in a security cautious way. The organization, e.g. a busines entreprise or company, gain lower cost of developing, maintaining and communicating security policies and rules, increased information security, increased return of investment in existing security technologies and products and reduced risk of costly security incidents.

The method is operated in two alternative set-up's: 1) in a hosted environment in order to provide the defined functions and services. 2) Stand-alone execution runs on servers at business users or business partners in order to provide the defined functions and services.

The computer system operates on a standard business style networked computer, for example a server type computer with hard drives, computing power, memory and input/output devices or the system operates on a dedicated computer device with storage capacity, computing power, memory and input/output devices.

The method and the computer system according to the invention is preferably implemented using software running on computers. The software contains user interface modules for each of the modules, business logic, persistence, an information security object database as well as interfaces between the users and the modules and interfaces in between the modules or services.

User Interface to Modules.

The technique according to the invention provides full functionality to users through an Internet browser, e.g. MS Internet Explorer, Netscape, Mozilla, or Opera.

The Email messages are used to direct users to the appropriate network address accessed by an Internet Browser.

Alternatively, the user interface to the modules is implemented using stand-alone applications (versus browser based).

Security policy applied to common data security architecture, e.g. U.S. Patent Application 20010018746 which is an architecture allowing users to generate trust policies independent of the computers they have the responsibility of managing.

Security management system and security managing method, e.g. U.S. Patent Application 20010023486, which is a database based security management and security audit system. This invention is about having users managing systems.

American vendors Pentasafe and Intellitactics' provide security policy management tools or services: One is a product named “Livingpolicy”, another is “Vigilent Policy Manager”. Both also provide simple surveying functions. Yes/No questionnaires which refer to security policy requirements are known prior to this invention.

Electronically performed surveys with functions which allows a manager type user, e.g. a security manager or e.g. an officer to put in free text style questions in a number of questionnaires to users are known.

E-learning systems and learning management systems are known. Security learning classes, also web based, are known. These classes target system administrators, or network administrators or security administrators, and do not target all relevant users in an organisation.

In some organisations or contexts the terms “security instruction” “security rule”, or “security procedure” are used instead or together with of the term “security policy”.

The technique according to the present invention is supporting multiple languages both in terms of the software itself and in terms of the content elements, e.g. the information security.

The policy module is a tool for security policy management. The users of the module use the Policy module to generate and manage a set of easy to use security policies. The content in these policies is re-used in the survey module and in the education module.

In this context, the term a “policy” is to be understood as a number of records in the policy table in the Information Security Object database (ISO-DB). The records relate to a specific customer organization and contain the following content.

| | | | | |
|---|---|---|---|---|
| Object | Object | Object | Content | Target group |
| Category | descriptor | Content | category | |
| and sub | | | | |
| category | | | | |

The Customer is an identifier optionally linking to a separate customer table further optionally linking to a CRM system. The operator (or superuser) creates a customer of the customer table of the database after receiving an order or after agreeing to a demonstration for a specific client.

The Object Category identifies the type of information security object to which the record relates. It contains text. E.g. does the information security object impact “computer user behavior”, does it impact only the “IT-department”, or is it about “physical access”. There will typically be a number of Information security objects with the same content category. Example: More than one information security object is to regulate the physical access to the customer's information assets.

The Information security object descriptor is the object description itself; it contains a text string or a link to a text string describing the object. Examples include: “Passwords are required to contain a variety of different character types.” and “Passwords are required to have a minimum length”. Objects are unique within the customer's policy, and the Manager selects the information security object from lists of object templates which content providers define. These lists are stored in tables for Information security object templates. Objects which are not already in the policy are marked e.g. “Unused”, or “New”, or Customer specific”.

The Object Content holds the content or the value of the Information security object. The value is a text string. The Manager chooses the content from a list where all entries relate to the Information security object. Example: If the Information security object specifies that a certain password length is required, the object content field contains the exact value, e.g. “eight characters” and the list contains a number of other content which in some cases are acceptable. In the list, a field named “default security rating” indicates which Object Content options content providers consider the more secure choices.

The Content category describes to which content categories the ISO belongs. Example: “Passwords”, “Computer security”, “Network Access”.

The Target group describes to whom the ISO relates. the number of ISO's within Security policies tends to become large. The effect of this value is reduction of the number of ISO's presented to individual group of users.

A superuser ads name of security policy into the information security object database (ISO-DB).
Either a Default security policy is created:
Superuser specifies the “default Security level profile” of the organization.
The system queries all information security objects (ISO) which matches the default security level profile and adds the result to the information security policy for the organization, hereby generating a default current security policy.

Or, the ISO's are created by ISO's containing existing text format security policies, security instructions, or security procedures.

The default security policy is subsequent managed by a management user: Information Security Objects are added, edited or deleted.

Those ISO's not included in the current security policy are listed as e.g. unused objects, making it easy for the management user to see, monitor and review these ISO's deliberately not used in the current policy.

Unused ISO's are made current by a simple selection.

New ISO's—e.g. organizational-specific objects—are added to customer's current policy by the management user entering the required content, e.g. content category, descriptor and value.

New default ISO's are added as the outcome of information security research performed by content providers.

The policies (or the security instructions, procedures etc) are published, distributed or communicated to the end users through email, web servers (e.g. Internet, extranet or intranet sites) and not at least through the survey module and the education module.

The users of the policy module are by default and unless otherwise defined the same throughout all modules.
Managers, who will typically be customer's security manager or security officer or consultant or a content provider who provides a manual policy service to the customer.
Superusers, who may be content providers.
Users, who will be computer users in the organizations of the customer.

The following table shows an example of user permissions:

| | User group: | | |
|---|---|---|---|
| Function: | Users | Managers | Superusers |
| Read policy | ✓ | ✓ | ✓ |
| Add policy | | ✓ | ✓ |
| Modify policy | | ✓ | ✓ |
| Delete policy | | ✓ | ✓ |
| Read information security objects | ✓ | ✓ | ✓ |
| Add information security objects | | ✓ | ✓ |
| Modify information security objects | | ✓ | ✓ |
| Delete information security objects | | ✓ | ✓ |
| Read object content | ✓ | ✓ | ✓ |
| Add object content | | ✓ | ✓ |
| Modify object content | | ✓ | ✓ |
| Delete object content | | ✓ | ✓ |
| Read object content templates | | ✓ | ✓ |
| Add custom object content templates | | | ✓ |
| Modify custom content templates | | | ✓ |
| Delete content templates | | | ✓ |
| Acknowledge policy read and | ✓ | | |
| understood | | | |
| Add Comment to Information security | ✓ | | |
| object and object content | | | |
| Add, invite and delete users | | ✓ | ✓ |
| Add, invite and delete managers | | | ✓ |
| Read survey content | ✓ | ✓ | ✓ |
| Add custom survey content | | ✓ | ✓ |
| Modify custom content templates | | ✓ | ✓ |
| Delete content templates | | | ✓ |
| Initiate surveys | | ✓ | ✓ |
| Answer surveys | ✓ | | |
| Read survey reports | | ✓ | ✓ |
| Edit survey reports | | | ✓ |
| Read and participate in learning | ✓ | ✓ | ✓ |
| sessions | | | |
| Update lessons | | ✓ | ✓ |

Display warning when user is trying to modify information security objects and object values which are already used in policies and have been read by users. Warning should suggest to consider adding a new object and value instead.

Information security objects and Object Contents are versioned and time stamped at last modification.

For Policy users, yet unread information security objects and object contents are marked “New”.

The survey module invites users at specified intervals to answer a questionnaire regarding general security knowledge and security policy specific knowledge. Invitations are made on manager's or user's request. Invitation e-mails are sent to users directly from the module to invited users or to customer's administrator. Emails contain a direct link (URL) to an online questionnaire relating to the customer and containing sufficient access information for the user to gain access to the questionnaire. The content of the invitation email is customizable and includes a default content provided.

The authentication of the survey users is based upon user's ability to receive an email at the specified email, by user name and password, or by digital certificates, or by LDAP-protocol to an external system or by other authentification method.

The user or users is or are presented to a short privacy policy description with a link to a wording which comfortingly and clearly describes what user data are stored and how the results of the survey will be used and by whom.

Users choose to respond anonymously resulting in that no personal information is stored, but the answers from the individual user are consolidate in the survey results. This feature provides that the manager chose to allow anonymous answers. Users choosing the anonymous option will be informed that questions might be repeated in later surveys and education.

The Survey system logs which users have answered, and a reminder process is initiated for those who did not participate before a deadline specified by the Manager. Default reminder is typically 7 days after first invitation email. Users are associated with a number of group descriptions to enable grouped reporting and to allow targeted, efficient follow up education.

Users are provided with their score and the right answers immediately. Administrator receives a report which documents the responses and provides summary to make it easy to identify weak points in security chain and to educate efficiently in the right places.

The Survey is repeated periodically as requested by the organization. The repetition allows to document the security level development and to add new components to policy or to awareness program as recommended.

The content of the survey questions and the defined right answers comes from a number of question pools. One pool is general knowledge questions and another is automatically derived from the ISO's.

The module generates survey result reports which are easy to read for people without security knowledge in e.g. executive staff or management as well as for security officers and managers. The reports contain graphically presented survey results documenting e.g. the following items:
Total knowledge score for company compared to average of all Survey respondents.
Total knowledge score for company compared to average in same business vertical.
Historical development in knowledge score with each previous survey results plotted along a time axis.
Total knowledge score grouped by department.
Total knowledge score grouped by Policy Categories.
Department knowledge score grouped by Object content category.
Historical development grouped by department.

The module also generates a report so that individual Users may see their own personal security score development chart.

The module supports PGP encrypted emails to administrator, by allowing administrator to upload public PGP Key.

The lessons contained in the education module are presented to the users with E-learning lessons in the education module. The lessons are using content from the central security object database.

The lessons which by default are offered to the user depends on the results from the survey module and upon which ISO content categories the Manager has chosen to activate for the customer organization to which the user belongs.

The user and the Manager have the option to select and de-select other modules than offered by default.

E-learning lessons or modules exist for each ISO content category and for many types of Information security objects.

An e-learning lesson lasts e.g. 20-30 minutes to complete for an average user.

The lessons are able to communicate both the generic information security content and content of the security policies in a motivating, appealing and catching way.

An audit module pulls out selected ISO's as defined by the policy module or by other modules. An audit list is generated automatically with all or selected ISO's. Each ISO constitutes a potential control point. For each control point it is indicated whether or not compliance is established. It is possible to make notes to the compliance statement. Users of the audit module may be central security officers requiring other parts of an organization to comply with various policies. Alternatively, the users may be employees who do self assessment of their policy compliance. Further alternatively, the users may be internal or external auditors, who are auditing the security policy compliance of an organization.

A risk analysis module defines, structures and contains the content of risk analysis report. This includes physical and information based assets, vulnerabilities, threats, risk or likelyhood of incidents, as well as consequences when/if incidents happen. The Risk Analysis module is linked to ISO's so that ISO's can be selected i order to reduce risk if desired.

An incident module defines, structures, logs and contains the content of security incidents. This includes incidents to physical and information based assets. The incident module is linked to ISO's so that ISO's can be selected in order to reduce risk of incident re-occuring if desired. The incident module links to the Risk analysis module so that historical logged data can be used to improve accuracy of risk or likelyhood of incidents in the Risk analysis module.

The database module contains the core data structures if the system These structures are implemented on a database platform which
Can be distributed as full runtime versions to deliver a “in a box” type solutions.
Gives a high level of platform in-dependencies in order to solve high security requirements.

The Management module includes:
Common user management routines for the three modules
User access and authentication modules.
Data maintenance routines and interfaces.

Admissions are authenticated at a higher level than end users, in order to meet the requirements of easy access to end users and high security in the system.

Using e-learning systems—online and offline—provides information security lessons with generic content to all—or to groups of—computer users throughout any organisation.

Effects: Users gain better understanding of general information security aspects and can operate their work place computer with increased information security as a result.

Using e-learning systems—online and offline—provides information security lessons with organisation-specific content to all—or to groups of—computer users throughout any organisation.

Effects: Users gain better understanding of the security policies, descriptions, procedures and requirements in the organisation of which they are a member. Users can process and work with organisation's information security assets, e.g. documents, data, general information security aspects in an increased secure way, compared to if users have not obtained this understanding through the invention.

Using multimedia, e.g. sound, speak, voices, animations, moving pictures, video recordings and recorded computer screen shots provide information security learning to computer users throughout the organisation.

Effects: Users become increasingly motivated to learn information security and to return to the learning process for further increased learning.

Having general Information security content and questions in electronically performed computer user surveys, the users receive the right security answers together with their own answers.

Effect: Survey participants become increasingly aware of the content in the survey. Users learn security. A survey report or management reports can be generated. A survey report can document the information security awareness among the computer users in the organisation. The survey results can also be used to target succeeding education more efficiently. The targeting can be done by groups of the organisation, or by individual.

The information security content is preferably provided as individual (for an organisational) Information security content and questions in electronically performed computer user surveys.

Effects: Survey participants become increasingly aware of the organisational-specific content in the survey. A survey report or management reports can be generated. A survey report can document the specific knowledge about the information security awareness among the computer users in the organisation. The survey results can also be used to target succeeding education more efficiently. The targeting can be done by groups of the organisation, or by individual.

The technique according to the invention provides information security awareness, security lessons and security surveys targeted to computer users throughout the organisation.

Effects: The weakest link in the information security link is strengthened by the invention. The information security link consists of technology/products/systems as well as end user behaviour. End users without sufficient knowledge are the weakest link, and when strengthened through the invention, end users can choose a secure behaviour when working and when using computers to process information assets.

Information security policies, Information security procedures, Information security instructions or, Information security rules are saved in a relational database. These document types are modularised and saved in a database as information security objects (ISO's) The objects contain, for example, specific or general information security objects and appropriate content or values of such objects.

### EXAMPLE

Assume a traditional style security policy specifies user' behaviour to be using password(s) with a certain minimum length, and assume that length is e.g. 6 characters long. In the relational database one record would be added with minimum the following information security object content:
1) Content category is “user behaviour”,
2) descriptor is “passwords with a certain minimum length are required to be used” and
3) the actual length which is required.
4) Target groups are “users” who need to set their password and “it-staff” who needs to set computer systems to enforce the minimum length

### EXAMPLE 2

Assume a traditional style security policy stipulates rules for how users shall treat information assets. On area of regulations is about employees having papers and documents on the desktops. Users are required to clean their desktop for confidential papers by the end of each working day. In the relational database one record would be added with minimum the following information security object content:
1) Content category is “information asset handling”,
2) “rules for cleaning employees desktop for information, e.g. documents and papers”
3) Employees must clean their desktop by the end of each working day.
4) The target group is “office employees of Company XYZ, Inc. ”

Effect: Database based security policies, security procedures, security instructions, or security rules can be created, managed and be in other contexts with less manual efforts compared to traditional security policies and traditional policy management tools. The increased effectiveness also has the effect of increased information security to organizations and to users as security policies, security procedures, security instructions, or security rules are foundations for improved information security in organizations of any type.

The ISO's are stored in a database and are used as modular content for e.g. Information security policies, Information security procedures, Information security instructions, and Information security rules. The ISO's are assigned an unique identifier allowing organizations which create and maintain e.g. security policies to link to the identifier. The ISO's are also assigned values for “default security level value”. The ISO's are also assigned a status value for each organization.

Effects: Increased re-use of ISO's, as organizations can choose and select content without “re-writing” default ISO's to go into their policies.

By specifying a default security level value for a specific organisation, the invention makes is possible to automatically create a default policy, simply by querying the default ISO's which match the default security level value of the organisation. The status value for each ISO makes it possible for an management user of an organisation to define values which sets the status. For example, ISO's with value “new since last” or “ready for review” can be processed and can be assigned a new status e.g. “Current” meaning it now is a part of the current policy. Similarly the status values can also have the effect of identifying which ISO's deliberately are not included in a policy, e.g. with the value “Unused”. The status value also makes it possible to add custom content in an organisation's policies, since e.g. the value “Custom” can be used as such.

The content of the information security objects are utilised for automatically generating relevant content of information security surveys. The ISO's which are also content in security policies are utilised for surveying e.g. user conformance, understanding, knowledge and awareness of the defined and current security policies and of information security aspects more general.

Effects: The surveys are generated much more effortless by re-using ISO's than by using traditional survey content and preparation methods.

The surveys contain more accurate and relevant content for the user. Organizations using this invention gain more accurate reporting on topics of relevance and improved information security.

### Example Content in Survey

The organisational specific parts of the survey are queried in the information security object database.

| | Answer | | |
|---|---|---|---|
| Question | options | Right Answer | Comment |
| Does you company | Yes/No | As defined in | |
| have a set of | | ISO-DB | |
| security policies? | | | |
| How aware are | Fully/well/ | Not defined | |
| you about the content | some/ | | |
| of the policies? | not at all | | |
| According to your | Yes/No/Don't | Yes if <Policy | Repeat until all |
| knowledge, does your | know | Category> is | categories have |
| company have policies | | found in | been asked |
| or rules about | | current policy | |
| “<Object Category>” | | | |
| According to your | Yes/No/Don't | Yes if | Repeat until all |
| knowledge, does your | know | <Information | objects have |
| company have a policy | | security | been asked |
| which defines | | object> is | |
| <information | | found in | |
| security object>” | | current policy | |
| According to your | List all Object | The Object | Repeat until all |
| knowledge, what does | Content | Content which | objects have |
| the policy say about | Templates for | is defined | been asked |
| <information security | the Information | in the Policy | |
| object>” | security object. | for this | |
| | | Information | |
| | | security object | |

For the general security knowledge part of Survey, the questions, answer options and right answers are managed by the Manager and Superuser in a way similar to the Policy Management.

A survey consists of a link to a policy, a number of questions, answer options, and indication of the right answer option together with a score for each option. Default score for the right answer is 10 and default score for wrong answers is 0. Questions are stored in a table in the security object database.

The answers are stored in a table which links to the user, to the questions and to the survey. If user requested to be anonymous, the answers are added to answer consolidation tables which allow for the Result reports to be generated without saving individual user responses.

The ISO's are used as (part of) the content in security learning.

Effects: Users of the information learning system will be presented not only with general knowledge, but also with the specific content of the organisation they belong to.

Users will learn not only the general knowledge but will also learn what ISO's manager users have decided are relevant for the users to know in their organization.

The ISO's are used as (part of) the content in audit reports. Audit reports link to specific security policies.

Effects: Internal or external auditors can audit specific security policy compliance. Audit reports reflecting real security policies and their control points can be generated with less manual work efforts. The invention can auto generate control points based upon ISO's.

Content from the ISO's are linked with contents in risk analysis reports (RAR).

Effects: RAR's can identify risk areas and ISO's in security policies can be used to reduce those risks, if desired by the organization and/or the users. Policies made with this link become more targeted to reduce real risks than without the link.

The incident module is linked to ISO's. The incident module links to the Risk analysis module.

Effects: ISO's in security policies can be selected more efficiently and can reduce risk of incident re-occuring if desired. Historical logged data can be used to improve accuract of risk or likelyhood of incidents in the Risk analysis module.

The user settings and permissions which are defined in the management module are re-used in the policy, survey and the education modules.

Effects: Users can without the need for repeating authentication routines (e.g. passwords) be educated and surveyed in e.g. security policies, security instructions, security surveys, security learning.

In the acompanying drawings, a first and presently preferred embodiment of the computer system according to the present invention is shown.

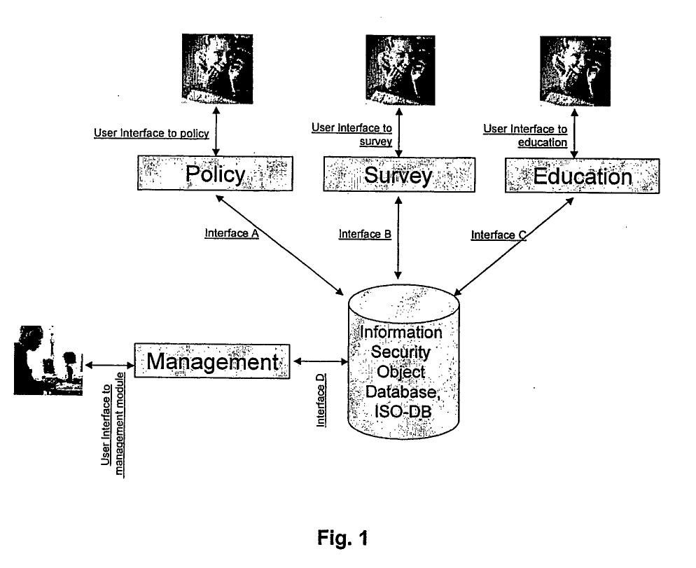

In FIG. 1, a diagramatic view is shown illustrating the structure of the computer system and the software thereof comprising centrally an information security object database ISO-DB connected through respective interfaces designated interface A, interface B, interface C and interface D to a policy module, a survey module, an educational module and a management module, respectively. The modules are further connected through respective interfaces to the users, either directly or through a network to the user PC's.

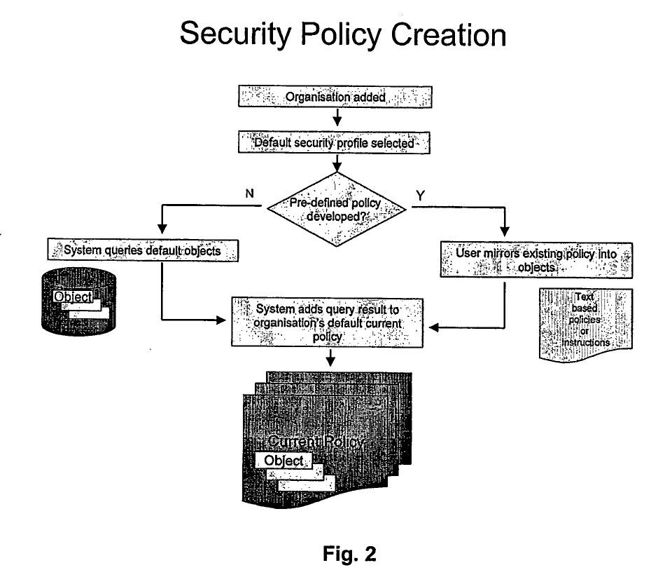

In FIG. 2, a route diagram is shown illustrating the security policy creation technique according to the present invention. It is contemplated that the diagram and the text thereof is self-explanatory and therefore, no detailed description of the diagram is presented.

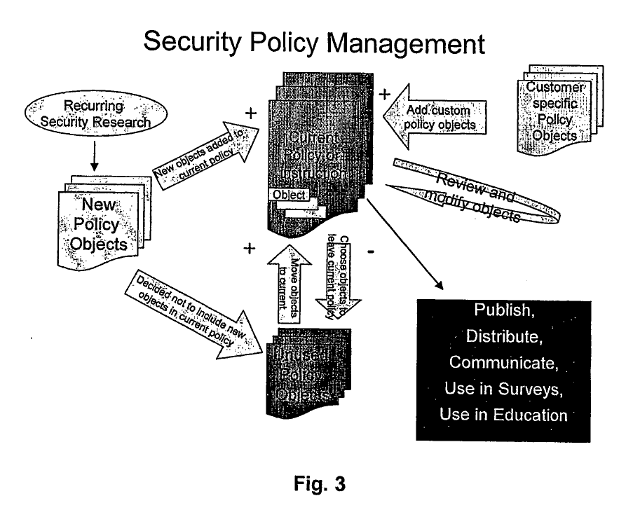

In FIG. 3, a block diagramatic view of the security policy management method and a system according to the present invention is shown. The block diagramatic view is contemplated to be self-explanatory and therefore, no detailed description of the diagram is presented.

Although the present invention has been described with reference to specific applications and a specific embodiment, the present invention is also to be contemplated including any modification obvious to a person having ordinary skill in the art and therefore, the scope of the invention is to be considered in view of the apending claims.

1. A computer system for providing security awareness in an organization, comprising:
a memory means, constituted by a hard disk or Random Access Memory device,
a central processor unit connected to said memory means,
an input device, constituted by a mouse or keyboard device, connected to said central processor unit, for the input of a piece of security information into said computer system for storing said security information in said memory means as an information security object,
an output device, constituted by a printer or display device, connected to said central processor unit for the output of security information,
a policy module communicating with said input device and said memory means for the conversion of said piece of security information into said information security object to be stored in said memory means, and
a survey module communicating with said memory means and said output means for generating from said information security object an element of a questionnary to be output by means of said output device.

2. The computer system according to claim 1, further comprising an educational module communicating with said memory means for receiving through said input device a set of answers to said questionnary and for comparing said set of answers of said questionary with said information security objects for determining the correct and the incorrect answers, and generating, based on said incorrect answers, an educational program to be output by means of said output device.

3. The computer system according to claim 2, said set of answers being stored in said memory means.

4. The computer system according to any of the claims 1-3, said memory means being organized as a database.

5. The computer system according to any of the claims 1-3, said computer system constituting a stand alone computer or alternatively a computer system including a network and a plurality of PC's each including an input device and an output device to be operated by a respective user.

6. The computer system according to any of the claims 1-3, said central processor unit controls in said conversion of said piece of said security information into said information security object, said policy module to check in said memory means the possible presence of a corresponding security information object.

7. A method of providing security awareness in an organization, comprising the steps of providing a piece of security information, storing said piece of security information in a memory means as an information security object, said information security object being generated in a policy module, generating in a survey module an element of a questionnary from said information security object and output said questionnary including said element.

8. The method according to claim 7, further comprising the computer system according to any of the claims 1-3.
